(19) United States
(12) Patent Application Publication
(10) Pub. No.: US 2014/0006195 A1
(43) Pub. Date: Jan. 2, 2014

(54) CHECKOUT SYSTEM AND METHOD

(71) Applicant: Naomi Wilson, Satellite Beach, FL (US)

(72) Inventor: Naomi Wilson, Satellite Beach, FL (US)

(21) Appl. No.: 13/931,291

(22) Filed: Jun. 28, 2013

Related U.S. Application Data
(60) Provisional application No. 61/665,830, filed on Jun. 28, 2012.

(51) Int. Cl. G06Q 20/32

(52) U.S. Cl. CPC G06Q 20/322
USPC 705/21

(57) ABSTRACT

A system and method for facilitating checkout, such as in retail establishments for example grocery stores, whereby a user utilizes a mobile device to collect product identification and pricing information. At checkout, the user presents the mobile device to the legacy scanning system of the retail establishments whereby barcodes or other graphic information symbols are presented to the scanner, enabling quick check out. Product, shopper, and other data related to the shopping experience may be collected and further utilized by the system provider. The system and method of the invention reduce the time required for checkout and enables the collection of data for later use by the system provider. Additional embodiments include the use of remote server generated QR codes or other graphic information symbols to further reduce checkout time. Data mining may be performed on collected user information and provide the businesses for marketing and advertising purposes.

### CROSS REFERENCE TO RELATED APPLICATIONS

This nonprovisional patent application claims the benefit of provisional patent application Ser. No. 61/665,830, filed in the United States Patent and Trademark Office on Jun. 28, 2012, which is incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The invention relates generally to the field of checkout systems and methods using electronic devices such as hand-held electronic devices, for example cellular telephones, to facilitate the itemization and purchase of items. Typical uses include, but are not limited to, retail store checkout systems such as, for example, grocery stores and the like.

2. Background Art

Systems and methods for checkout which utilize electronic scanning of product labels such as bar codes and the like are known in the art. Such systems are used to facilitate the identification and payment for products purchased in, for instance, retail establishments such as grocery stores or “big box stores” and the like. The earliest of these systems relied upon electronic scanning in the form of laser scanning to scan product labels so that cashiers no longer had to enter the price of each product by hand into a checkout terminal or similar device. Such systems eliminated, to a large degree, the errors associated with hand entry of pricing for products during checkout. However, these systems still require each product to be purchased to be handled individually for scanning. Therefore, although the systems did reduce the historical error rate of pricing entries, the time required for a cashier to individually scan each item remained a significant component of the total time to check out for the retail establishment.

Other systems have since been conceived which rely upon hand-held electronic units, or mobile devices, for purchasing products. For instance, U.S. Pat. Nos. 7,593,873, 7,680,702, and 8086497 to Oakes which disclose a system for purchasing products comprising at least one subsystem that receives from a mobile device at least price and seller identification data of a product, (at least the price of said product having been electronically read by the mobile device), and at least one subsystem that charges a user for the product based upon the received price and identification data.

Another system known in the art is disclosed in U.S. patent application publication number US 2006/0293968 A1 which discloses a media enhanced shopping cart system comprises a shopping cart comprising a frame, a basket, a handle, a base tray, and a plurality of wheels, an inventory component for determining an inventory contained by the shopping cart, an identification component for associating a unique identity of the shopping cart, a correlation component of a modular computing device for correlating the inventory contained by the shopping cart with the unique identity of the shopping cart, and a communication component for conveying to a retailer system the correlation between the inventory and the unique identity of the shopping cart.

Still further is the system disclosed in US patent application publication number U.S. 2009/0055278 A1, which discloses the use of a scanning technology comprising radiofrequency identification (RFID) to identify product price and validate transactions during a shopping session in a retail location and streamline the payment process by electronically transmitting credit card information directly to the user's financial institution to authorize payment.

A significant roadblock to the implementation of the systems of the prior art is that they require a substantial level of integration with a particular retail store's inventory and checkout system. Such integration generally requires the development of custom software at a minimum. Furthermore the rollout of such complex and integrated systems across a number of retail locations represents significant training, integration, and other challenges. What is needed is a simple self-checkout system that is interoperable with the existing legacy scanning systems already in use in the retail industry so that the cost and risk of a complex integration effort is avoided. The present system and method overcome the disadvantages of the prior art.

### BRIEF SUMMARY OF THE INVENTION

The present invention comprises a system and/or method that has one or more of the following features and/or steps, which alone or in any combination may comprise patentable subject matter.

In accordance with one of the simplest embodiments of the present invention, the invention, a user, such as, by way of example and not of limitation, a shopper in a grocery store or other retail establishment, utilizes a mobile electronic device such as a personal digital assistant, cellular telephone, electronic tablet, or any other mobile electronic device to scan the product identifier of a product which is desired to be purchased. The user then may place the product in the shopping cart and continue on to identify the next product, if any, to be purchased. Once the next product to be purchased is identified, the user may use the mobile electronic device to scan in its product identifier, and so on, until the user has scanned in the product identifiers of the products that are desired to be purchased. In this manner the user creates a list of scanned product identifiers in the memory of the mobile electronic device while filling the shopping cart with products to be purchased. Upon checkout the user presents the mobile electronic device to the legacy laser scanner system whereupon the product identifier, for example but not limited to a barcode, for each product to be purchased is sequentially displayed on a screen of the mobile electronic device allowing the legacy laser scanner system to scan and bar code for each product to be purchased. In this manner the individual handling of each product from the shopping cart is eliminated, this dramatically reducing the time required to complete checkout. After the last barcode is scanned by the legacy laser scanning system, the total price of the purchase may be calculated by the legacy system, the payment may be completed, and the user may exit the store.

Additional embodiments of the invention include provisions for creating shopping lists, deleting shopping lists, editing shopping lists, recording and displaying a list of items that have been picked and placed in the shopping cart, displaying a running tally of the total price to be paid by the user, and the like. Furthermore, the system and method of the invention may be used to provide product pricing comparisons and may also be utilized by the provider of the system to perform data mining operations, and collect such data as frequency of shopping, the identification and quantity of items purchased, location and demographic data regarding the shopper, cellular phone information, and the like. Such information may have commercial value and may therefore be a significant component of the business model employed by the provider of the system.

Still further additional embodiments of the invention comprise a cloud or internet based checkout system and method in which the user's purchase information is bundled together and transmitted to a remote server. The remote server utilizes the purchase information transmitted by the user of the system to generate a graphic information symbol representing the product purchases to be made by the user. An example of such a graphic information symbol is a Quick Response, or QR code. Contained within the graphic information symbol may be information such as product identification data, product price data, and other data as may be desired by the system provider. In this embodiment of the system and method of the invention the user simply presents the hand-held electronic device which displays upon its screen the graphic information symbol, which may be a QR code or similar symbol, to the legacy scanner system whereby the legacy scanner system scans the graphic information symbol to retrieve product identification and price data, and other data as the system provider may desire to complete the checkout process.

Still further additional embodiments of the invention comprise functionality allowing the user to check out using simply their mobile device. In these embodiments, the user's financial account information such as credit card or debit card information is embodied in the graphic information symbol and is used to immediately check the user out and to effectuate payment. In this embodiment of the system the user presents the mobile device to the checkout scanner, which scans the graphic information symbol displayed on the mobile electronic device visual display to retrieve product identification, product pricing, and user financial account information in order to effectuate checkout.

In this disclosure, the “system provider” is defined as the entity which deploys the system for use and the “user” of the system is defined as, for example, the retail shopper who is actually making the purchase of products. “Legacy scanning checkout system” means a point of sale checkout system that employs an optical scanner to scan product identifiers such as, for example and not by way of limitation, product bar codes.

While the various embodiments described in this application disclose the use of the present system and method of the invention in a retail establishment such as a grocery store, it can readily be seen if the system and method of the invention are not limited by their use in a retail establishment. The system and method of the invention have broad application far beyond retail establishments and thus the use of the system and method of the invention should not be construed as limited to use in retail establishments such as grocery stores. The retail examples provided in this disclosure are exemplary only.

### BRIEF DESCRIPTION OF THE DRAWINGS

The accompanying drawings, which are incorporated into and form a part of the specification, illustrate one or more embodiments of the present invention, and, together with the description, serve to explain the principles of the invention. The drawings are only for the purpose of illustrating the preferred embodiments of the invention and are not to be construed as limiting the invention. In the drawings:

FIG. 1 depicts an exemplary flowchart for the initial steps of the system and method for a basic embodiment of the invention.

FIG. 2 depicts an exemplary flowchart for the checkout steps for a basic embodiment of the system and method of the invention.

FIG. 3 depicts the physical elements of an embodiment of the system of the invention.

FIG. 4 depicts an alternate embodiment of the invention in which QR codes or similar graphic information symbols are used to capture the entirety of products purchased in a single shopping session.

FIG. 5 depicts an alternate embodiment of the invention in which QR codes or similar graphic information symbols are used to capture the entirety of products purchased in a single shopping session and are further utilized to complete the purchase of the products.

FIG. 6 depicts a user of the system 601 utilizing the invention to scan a product bar code 301 using the optical scanning feature 602 of a mobile electronic device 309.

FIG. 7 depicts an exemplary screen shot of a preferred embodiment of the invention in which a product identifier has been optically scanned.

FIG. 8 depicts an exemplary screen shot of an alternate embodiment of the invention in which a product has been determined to be on sale or near the shopper, causing sale or coupon information to be displayed on the visual display of the mobile electronic device.

FIG. 9 depicts an exemplary screen shot of an alternate embodiment of the invention in which a coupon has been scanned, and coupon information is displayed on the visual display of the mobile electronic device.

FIG. 10 depicts an exemplary screen shot of an alternate embodiment of the invention in which user profile and award points information may be displayed on the visual display of the mobile electronic device.

FIG. 11 depicts an exemplary screen shot of an alternate embodiment of the invention in which user gift information may be displayed on the visual display of the mobile electronic device.

FIG. 12 depicts an exemplary screen shot of an alternate embodiment of the invention in which a user may scan a coupon, whereupon coupon and product information may be displayed on the visual display of the mobile electronic device.

FIG. 13 depicts an exemplary screen shot of an alternate embodiment of the invention in which a coupon for a selected product has been identified and displayed on the visual display of the mobile electronic device.

FIG. 14 depicts an exemplary screen shot of an alternate embodiment of the invention in which a promoted product is presented to the user by display on the visual display of the mobile electronic device.

FIG. 15 depicts an exemplary screen shot of an alternate embodiment of the invention in which user points awards upon checkout may be displayed on the visual display of the mobile electronic device.

FIG. 16 depicts an exemplary screen shot of a preferred embodiment of the invention in which a product identifier may be displayed on the visual display of the mobile electronic device for checkout.

FIG. 17 depicts exemplary screen shots of a preferred embodiment of the invention in which product identifiers may be sequentially displayed on the visual display of the mobile electronic device for checkout.

FIG. 18 depicts an exemplary screen shot of a preferred embodiment of the invention in which a coupon bar code may be displayed on the visual display of the mobile electronic device for checkout.

FIG. 19 depicts exemplary screen shots of a preferred embodiment of the invention in which coupon bar codes may be sequentially displayed on the visual display of the mobile electronic device for checkout.

FIG. 20 depicts an exemplary screen shot of an alternate embodiment of the invention in which a QR code or other graphic symbol providing a link to bundled product purchase information on a remote server is displayed on the visual display of the mobile electronic device for checkout.

FIG. 21 depicts an exemplary screen shot of an alternate embodiment of the invention in which a QR code or other graphic symbol, including a payment confirmation number, providing a link to bundled product purchase information on a remote server is displayed on the visual display of the mobile electronic device for checkout.

FIG. 22 depicts an exemplary screen shot of an alternate embodiment of the invention in which a retail establishment's QR or other graphic code has been scanned by the mobile electronic device.

FIG. 23a depicts an exemplary screen shot of an alternate embodiment of the invention in which a list of the products purchased are listed by receipt date and location.

FIG. 23b depicts an exemplary screen shot of an alternate embodiment of the invention in which a list of the products purchased are listed by price.

### DETAILED DESCRIPTION OF THE INVENTION

The following documentation provides a detailed description of the invention in its various preferred and alternate embodiments.

In this disclosure the term mobile electronic device means cellular telephone, personal digital assistant, electronic tablet and any hand-held electronic device which comprises the capability to scan a graphic information symbol such as a barcode; the capability to be carried by the user; the capability to execute a sequential series of steps such as those identified in this disclosure; and the capability to display information on a visual display. In some of the additional alternate embodiments of the system and method of the invention the mobile electronic device may further comprise the capability of communicating with a remote server such as over the cellular telephone network, wireless networks such as WiFi or Bluetooth or other wireless communication; reading radiofrequency ID tags. Such mobile electronic devices are currently known in the art and are typically comprised of microprocessors, memory for the storage of data and program instructions for carrying out the system and method of the invention, and input and output devices such as screens, touch screens and keypads. The physical implementation of the functional features of the mobile electronic device of the system and method, such as use and choice of processor, memory, or visual display elements of the invention are not to be construed as limitations of the invention. A software application in the form of software programming or code that contains instructions for carrying out the various steps of the invention may reside in the memory or other component of the mobile electronic device, as is well known in the art.

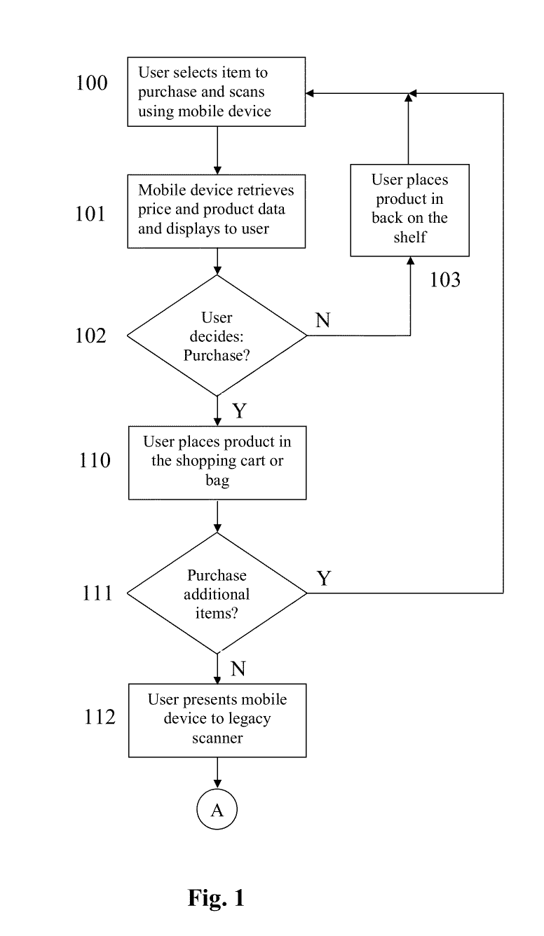

Referring now to FIG. 1, a user of the system, who may be for instance a retail shopper in a grocery store, selects an item to purchase from among the possible selections in the store 100. Upon deciding to purchase the product the user utilizes the optical scanning capability of the mobile electronic device to scan a product identifier, for instance, the barcode of the product, or any other product information that is present on the product itself or may be present on associated labeling such as, for example, shelf labeling. Alternatively, the user may enter in a product identifier or product information through the use of a keyboard, voice recognition, or other human interface on the mobile electronic device product information sufficient for the mobile electronic device to retrieve price and product data 101. The price and product data retrieved may be presented to the user on the mobile device's visual display 101. The user may then decide to either purchase or not purchase the product 102. If the user decides to not purchase the product, the product is placed back on the shelf 103 and the user proceeds onto the next product desired to be purchased 100. If the user decides to purchase the product, the product is placed, for example, in the shopping cart or shopping bag 110. If there are additional purchases the user desires to make 111, the user proceeds to select the next product 100. If there are no additional purchases the user desires to make 111, the user then proceeds to the checkout process whereby the user presents the mobile electronic device to the legacy scanning system of the retail establishment 112. This ends the flowchart for the initial component of the system and method of the invention A.

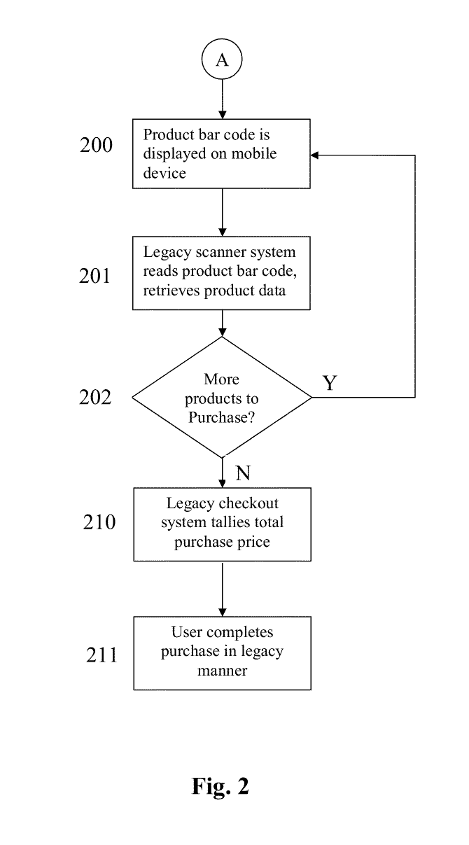

Referring now to FIG. 2, the next stage of the system and method of the invention is depicted, namely the checkout procedure. After completing the product selection process described in FIG. 1, the user proceeds to complete the checkout process A. Upon presentation of the mobile electronic device visual display to the legacy scanning system of the retail establishment 112, a product identifier, for example a bar code, for each of the products to be purchased is presented on the visual display of the mobile electronic device 200. The barcode thus presented is scanned into the legacy scanning system 201. The legacy scanning system then retrieves product identification and price information from the legacy product database 201. If there are additional products to purchase 202, this process is repeated in like fashion until all products which have been scanned and into the user's mobile electronic device have been scanned into the legacy system for final purchase. If there are no further products to purchase 202, the legacy check out system tallies the total purchase price 210 and presents the total purchase price to the user for payment. The user then completes the purchase by paying in any of the normal methods of payment which may include cash, check, credit card, debit card, or any other means for payment known in the art 211.

It can be seen and appreciated that the system and method of the invention does not require modification of the retail establishment's legacy scanning, inventory, or checkout systems because the product identifier displayed to the legacy scanning system may be, for example, the same type of bar codes which the legacy system scans in its legacy operation. Thus the time required for product identification, pricing and checkout are greatly reduced without the need for any modification of the retail establishment's legacy systems.

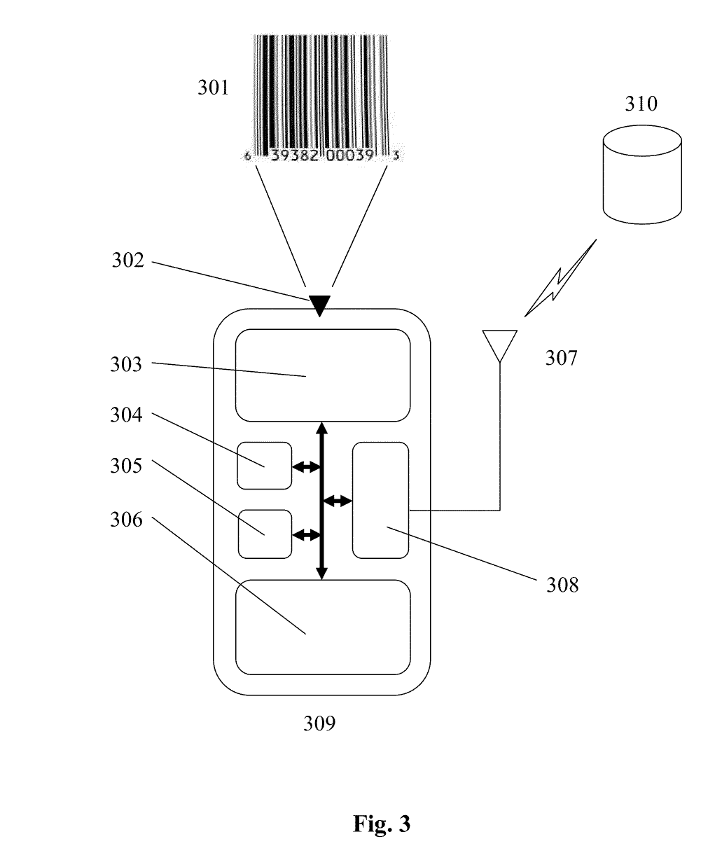

Referring now to FIG. 3, the physical elements of an embodiment of the system of the invention are depicted. Mobile electronic device 309 may comprise a processor for the execution of the steps of the invention 304, a memory for storage instructions relating to the steps of the invention 305 and for storing product information, a visual display 303, wireless interface transceiver 308 and antenna 307, scanning element 302 for the reading of product information 301 and manual input device 306 which may be, for example, a keyboard or a soft keyboard such as those used on touch screen devices. Each of the elements of mobile electronic device 309 are in electrical communication with one another. Mobile electronic device 309 may communicate with remote server 310 via any of the known methods and communications channels known in the art: for example, the cellular telephone network, Wi-Fi, Bluetooth, infrared communications ports or any other communication channel and method. The particular communication channel and method may be of any type known in the art and is therefore not a limitation of the system and method of the invention.

An alternate embodiment of the system and method of the invention utilizes a graphic information symbol such as, for example, a QR code to bundle the product identification and pricing information in order to further reduce the checkout time by eliminating the need to individually scan each product bar code at checkout. A QR code (short for “Quick Response”) is a type of barcode that, upon scanning, instructs the processor of a Web-enabled device to immediately follow a link to information desired to be provided to a user.

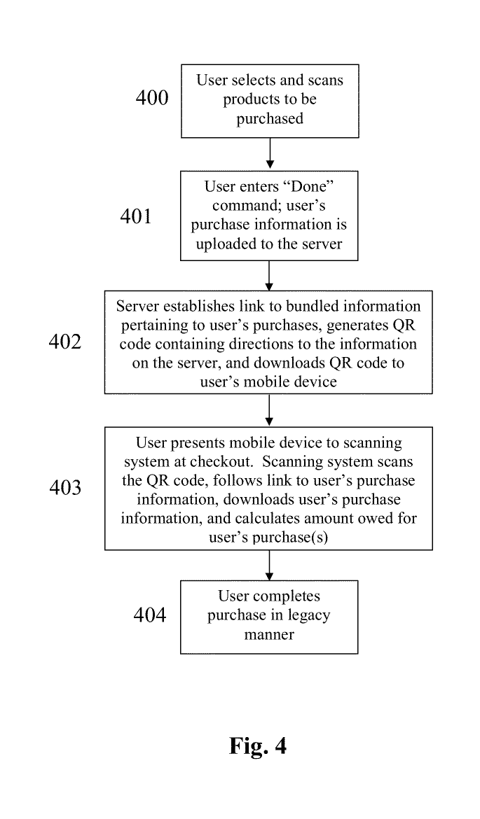

In yet a further embodiment of the invention referred to herein as “bundled checkout”, information regarding products to be purchased, termed “product purchase information” herein, is communicated to a remote server whereupon the product purchase information may be bundled and associated with a graphic symbol or other identifier such as a QR code. Referring now to FIG. 4, the user selects items for purchase and scans their product labels 400 to produce a list of products desired to be purchased in the mobile electronic device memory. If a user changes their mind about a particular purchase, the system and method of the invention includes functionality to enable deletion that particular product from the purchase list. Once a user has completed the task of selecting and scanning the product information 400 for products to be purchased, the user executes a “done” or equivalent command 401 on the mobile device which notifies the system and method of the invention that the user has completed selecting and scanning products. Once the user has completed the process of selecting and scanning products, the product purchase information regarding the user's prospective purchase may be uploaded via the mobile device's transceiver to a remote server where the user's product purchase information may be bundled together to produce a bundled list of product purchase information which may contain product identification, product pricing, coupon information and other information as the system provider desires 402. Once the user's purchase information is bundled, a QR code or similar graphic information symbol is generated and downloaded to the user's mobile device 402. Upon checkout, the user presents the mobile electronic device to the checkout scanning system whereupon the scanning system scans the QR code or similar graphic information symbol which is displayed on the mobile electronic devices visual display, follows the associated link via an Internet connection to the server, downloads the user's purchase information, and tallies the amount owed for the purchase 403. The user then completes the purchase in any manner known in the art 404.

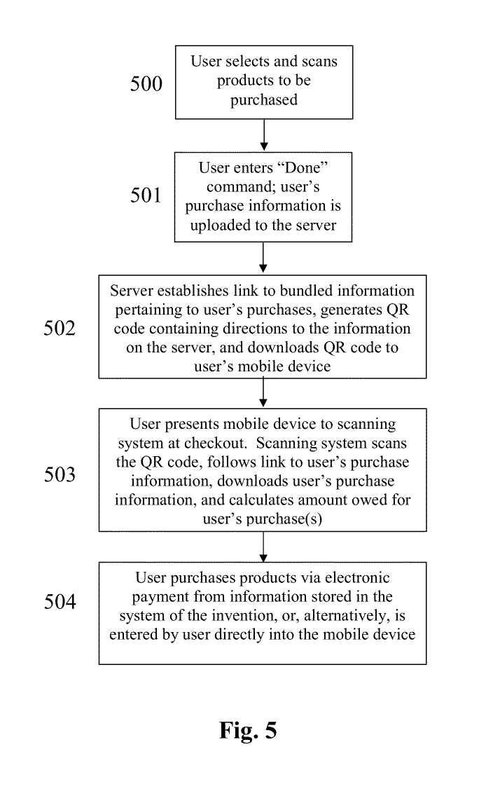

In yet a further alternate embodiment of the system and method of the bundled checkout embodiment of the invention, the invention may be used to complete the user's purchase of the selected products. Referring now to FIG. 5, the user selects items for purchase and scans the product labels 500 to produce a list of products desired to be purchased in the mobile electronic device memory. Once a user has completed the task of selecting and scanning the product information 500 for items to be purchased, the user executes a “done” command 501 on the mobile electronic device which notifies the system and method of the invention that the user has completed selecting and scanning products. Once the user has completed the process of selecting and scanning products, the product information regarding the user's prospective purchase is uploaded via the mobile electronic device's transceiver to a remote server where the user's purchase information is bundled together to produce a bundled list of information which may contain product identification, product pricing, user financial account information and other information as the system provider desires 502. Once the user's purchase information is bundled, a QR code or similar graphic information symbol is generated and downloaded to the user's mobile electronic device 502. Upon checkout, the user presents the mobile electronic device to the checkout scanning system 503 whereupon the scanning system scans the QR code or similar graphic information symbol, follows the associated link via an Internet connection to the server, downloads the user's purchase information, and presents the user's financial account information, such as credit card or debit card information, to the legacy checkout system. The checkout system may then deduct the funds for payment directly from the user's financial account 504. In this manner it is unnecessary for the user to swipe their credit card or debit card or to write a check during the checkout process as the payment process is automated by the embedding of the user's financial account information in the QR code is presented to the checkout scanner.

In yet a further alternate embodiment of the bundled checkout embodiment of the invention, a manual method for presentation of the bundled list of information to the legacy checkout system may be implemented as follows. The QR or similar graphic symbol code generated by the remote server, which contains the bundled information as described above, may also contain an identifying number or alphanumeric code that uniquely identifies the user. Once the remote server has bundled the list of information, the user or checkout clerk may enter the identifying number or alphanumeric code into the legacy checkout system by using a keypad or any other means known in the art to enter data into a legacy checkout system. When the identifying number or alphanumeric code is entered into the legacy checkout system, the legacy checkout system may communicate with the remote server and may download the list of products to be purchased and the pricing of products to be purchased. The legacy system may also download user identifying information for presentation to the user for confirmation of the user's identity and confirmation of the purchase to be made, and may also download a total purchase price and other information that may be helpful to the user or to the checkout clerk or retail establishment. The user may then complete the purchase by making payment in any manner known in the art. The identifying number or alphanumeric code may also be associated with credit or debit account information specific to the user such that the user's credit or debit account is debited for the purchase of products after entry of the identifying number or alphanumeric code into the legacy checkout system.

In yet another embodiment of the bundled checkout embodiment of the invention, the user may have, through online or other means, entered her personal credit, debit, or digital wallet account information into the memory of the mobile electronic device or may have entered such information into the remote server by logging into the remote server using the internet or any other known means for communication with a remote server. Upon checkout, the user may select her desired method and account for payment, and the payment for her purchase may be allocated or otherwise held in escrow by her financial account service so that, when she approaches the legacy checkout system, payment may be automatically made after the QR or similar graphic symbol code is scanned or entered into the legacy system and after the legacy system has pulled the product purchase information down from the remote server. Funds may then be transferred from the escrow account to the store account, completing the purchase.

In yet a further, and more automated, embodiment of the bundled checkout embodiment of the invention, the user may bypass the legacy checkout system altogether. In this alternate embodiment, the user may authorize payment from debit, credit, or digital wallet accounts after she has scanned all the products to be purchased. In this embodiment, the remote server may add payment confirmation information to bundled product purchase information and then communicate a QR or similar graphic symbol code to the user's mobile electronic device which provides a link to the user's bundled product purchase information, whereupon the QR or similar graphic symbol code may be displayed upon the visual display of the user's mobile electronic device and presented to a door clerk upon exit of the retail establishment. The door clerk may then scan the QR or similar graphic symbol code displayed on the user's mobile electronic device visual display using an optical scanning device. The door clerk may then verify that payment has been made and may verify the identity and quantity of items purchased and may take an inventory of the user's shopping cart or bag in order to prevent theft.

In yet a further alternate embodiment of the invention, items in the user's shopping cart or bag may comprise Radio Frequency Identification (RFID) tags. These RFID tags are generally used by retail establishments to identify and prevent shoplifting. In an further alternate embodiment of the invention, the RFID scan of a user's shopping cart or bag may be compared to the bundled product purchase information for a user and may therefore be useful for identifying theft of items placed in the user's shopping cart or bag which were not scanned by the user, and therefore were not purchased upon checkout.

While the various embodiments described herein disclose the use of the QR codes as a graphic information symbol containing a link to the purchaser's bundled information, it is to be understood that any graphic element that is usable to communicate such information is within the scope and breadth of the invention. It is not therefore a limitation on the system and method of the invention that the graphic information symbol be construed as being limited to QR codes only.

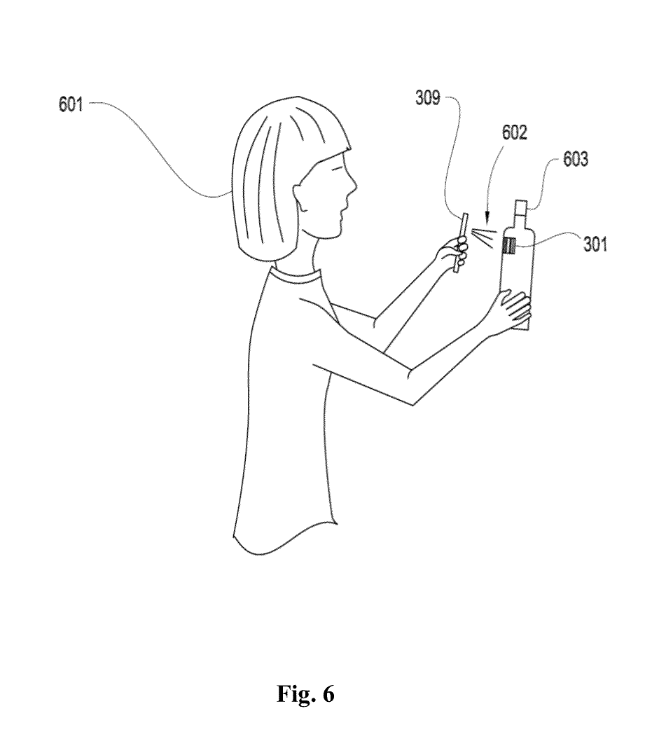

FIG. 6 depicts a user of the system 601 utilizing the invention to scan a product identifier 301 for product 603 using the optical scanning 602 from a mobile electronic device 309.

A still further alternate embodiment of the system and method of the invention is comprised of instructions which collect user purchase information such as identification of products purchased, usage of sales and coupons, dates and times of shopping, user demographic information, geo-location information, and other shopper and purchase specific information. Such information may be analyzed and correlated to develop qualified advertising leads, statistical demographic, geographic and other information, user contact information, and other information which may be useful in marketing and advertising of products and potential customers of businesses utilizing the system and method of the invention. This information may be analyzed, mined, manipulated and provided to businesses utilizing the system and method of the invention as an incentive for such businesses to continue use of the present invention. In this manner businesses may utilize the present invention and realize a significant advantage in their ability to reach qualified potential customers with targeted sales campaigns and the like.

A still further alternate embodiment of the invention utilizes GPS geo-location data to ascertain the user's presence at a particular retail store. The system and method of the invention may then download to the user messages provided by the retail store to the remote data server. In this manner, the system and method of the invention may provide customer loyalty rewards, coupons, special offers, in other words that the product is on sale, and the like to the user of the system based upon the invention's understanding that the user is present in a particular retail store.

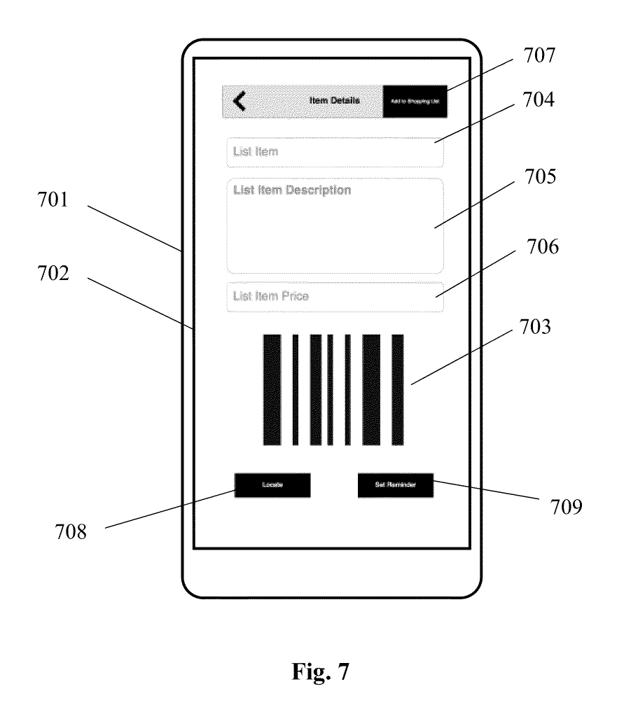

The invention may present its several features and elements by display on the visual display of the mobile electronic device in any format that is suitable for display of information to a user. The location and design of the graphic features depicted in the figures are meant to be exemplary and not limiting. Exemplary screen shots from a typical mobile electronic device are depicted in FIGS. 7-23b and are described further below.

Referring now to FIG. 7, an exemplary screen shot from one embodiment of the invention is depicted. This screen may be displayed upon the mobile electronic device 701 visual display 702 after scanning a product's product identifier, which may be, for example, a bar code, or by entering a product identifying code into the mobile electronic device by any of the well-known means in the art such as through use of a keyboard, voice entered information using voice recognition features of the mobile electronic device, wireless communication to the mobile electronic device, or other known means for entering data into a mobile electronic device. Product identifier 703, which in the example shown, is a bar code but may be any product identifier, is displayed on the mobile electronic device visual display. An alphanumeric product name 704 may be displayed on the mobile electronic device visual display, as well as an alphanumeric product description 705, which may contain any information regarding the product. The product price 706 may also be displayed upon the mobile electronic device 701 visual display 702. The product may be added to a list of items to be purchased by clicking, selecting, pressing or otherwise activating button 707. The user may select button 708 to instruct the invention to locate the product or similar products within the store, or to search the World Wide Web to locate the same or similar products at nearby stores. Upon location, the invention may display location information on the visual display 702 of the mobile electronic device 701. A reminder may also be set by the user by selecting button 709, upon which the user may enter a time or date for the invention to display a reminder to the user to add the product to a shopping list. In an alternative embodiment, the invention may review the history of purchase made by the user from shopping lists stored in memory or stored online, and may make suggestions or reminders for products that are purchased substantially periodically.

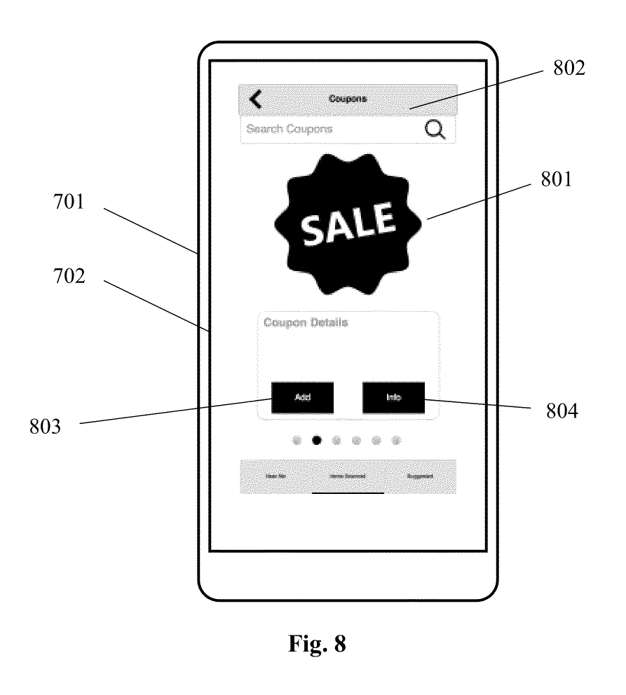

Referring now to FIG. 8, a further exemplary screen shot from one embodiment of the invention is depicted which provides an indication to the shopper that the product is on sale. This screen may be displayed upon the mobile electronic device 701 visual display 702 after scanning a product's product identifier, which may be, for example, a bar code, or by entering a product identifying code into the mobile electronic device 701 by any of the well-known means in the art such as through use of a keyboard, voice entered information using voice recognition features of the mobile electronic device 701, wireless communication to the mobile electronic device 701, or other known means for entering data into a mobile electronic device 701. The mobile electronic device 701 may search the World Wide Web for sale information or coupon information related to the product. A sale indication icon 801, which may be of the form shown or may be any shape and contain any lettering that indicates the product is on sale, is displayed on the mobile electronic device 701 visual display 702 if it determined that the product is on sale. Available coupons for the product may also be viewed by the shopper by selecting button 802. Coupons may be stored in a list in the memory of mobile electronic device 701, and may be added to the list by selecting button 803. Information about the coupon such as expiration date, value of the coupon, and any other coupon information may be displayed by selecting button 804. The invention may also suggest coupons and sale information for the scanned product that may be offered by nearby stores, or may offer suggestions for coupons or sale information for related items in the same or nearby stores. The invention may also be utilized to suggest products to the user, such as products that are the subject of product promotions.

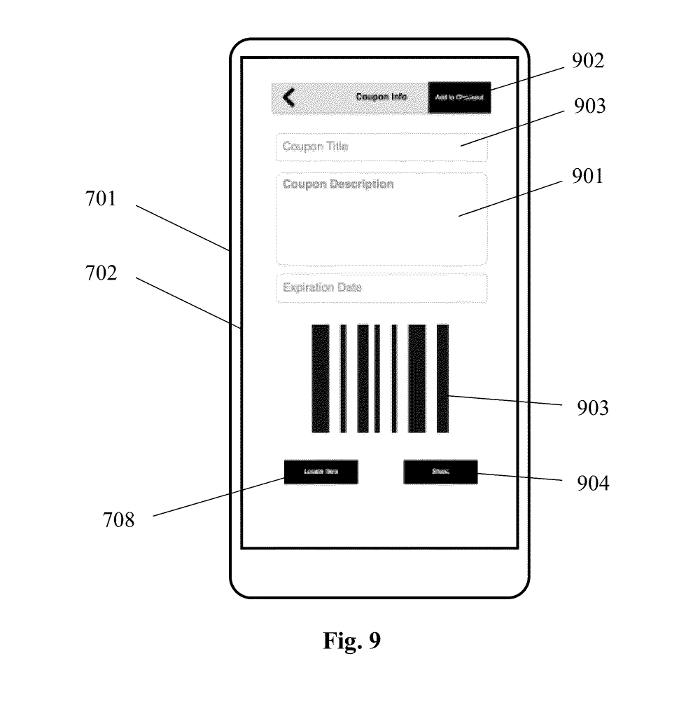

Referring now to FIG. 9, an exemplary coupon information screen of an alternate embodiment of the invention is depicted. A user may, for example, scan a coupon image using the optical scanning feature of the mobile electronic device 701. Coupon description 901 and coupon title 903 may be displayed on visual display 702 of mobile electronic device 701. The coupon may also have an associated bar code 903 that may also be displayed. The user may add the coupon to the list of coupons to be scanned at checkout by selecting button 902. A user may select button 708 to instruct the invention to locate the product or similar products within the store, or to search the World Wide Web to locate the same or similar products at nearby stores. Upon location, the invention may display location information on the visual display of the mobile electronic device 701. A user may also select button 904 to share the coupon with a friend via any social network service, by email, by text, by instant messaging, or by any other means for communication known in the mobile electronic device art.

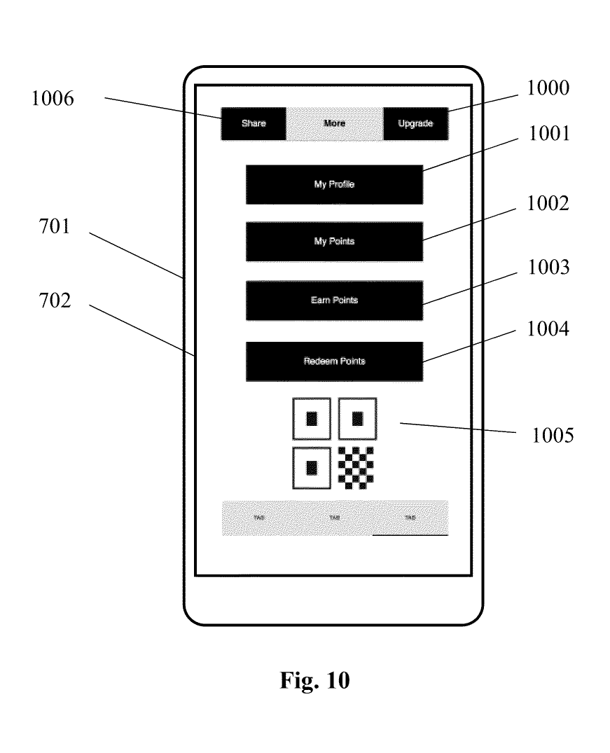

Referring now to FIG. 10, an exemplary user information screen of an alternate embodiment of the invention is depicted. A user may enter identifying and other information into the invention by selecting button 1001 and entering name, e-mail address, contact information, social network login credentials and other personal information as the system may require. A user may also enter financial information such as bank account information, credit card information, debit card information or financial information which may be useful for the completion of financial transactions. The invention may also offer reward points that, when accumulated to certain predefined levels, of discounts, sales, coupons, special offers and other rewards to the user. The invention may comprise button 1002, which, when selected, may allow a user to review the accumulation of points. The invention may also comprise button 1003, which, when selected, may allow a user to review the various methods for a user to earn reward points. The invention may also comprise button 1004, which, when selected, may allow a user to redeem reward points by, for example, downloading coupons valuable information to the mobile electronic device 701, by downloading a value to the user's accounts and various establishments which may be participants in the reward system of the invention, or any other known method for gifting or rewarding known in the art. The invention may also comprise button 1006, which, when selected, may allow a user to share the invention, which may be in the form of a software application available for download to a mobile electronic device 701, with another potential user of the invention. A user may also share product information, coupon information, or bundled purchase information with another person by selecting button 1006. The QR code to be shared 1005 may be displayed on visual display 702 of mobile electronic device 701. The invention may also comprise button 1000, which, when selected, may allow a user to upgrade to a premium version of the invention which may remove certain limitations such as, for example, a limitation on the total number of products that may be included in a shopping list, or any other limitation that may be programmed into the invention.

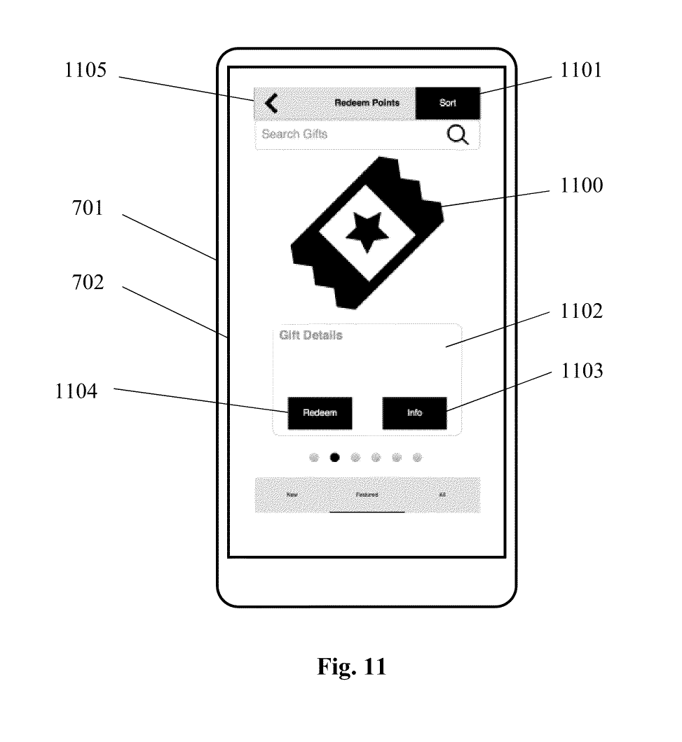

Referring now to FIG. 11, an exemplary reward point redemption screen of an alternate embodiment of the invention is depicted. Upon accumulating a predetermined number of award points, the invention may display gifts which are available by the redemption of award points by the user. The invention may, for example, display gift identifying graphic symbol 1100, and may also display gift details window 1102, the invention may display button 1103, which, when selected, may allow a user to view additional information about the gift. The invention may display button 1104, which, when selected, may allow a user to redeem award points for a particular gift. The invention may also display button 1101, which, when selected, may allow a user to sort available gifts. The invention may display button 1105, which, when selected, may allow a user to navigate back to a previous screen display.

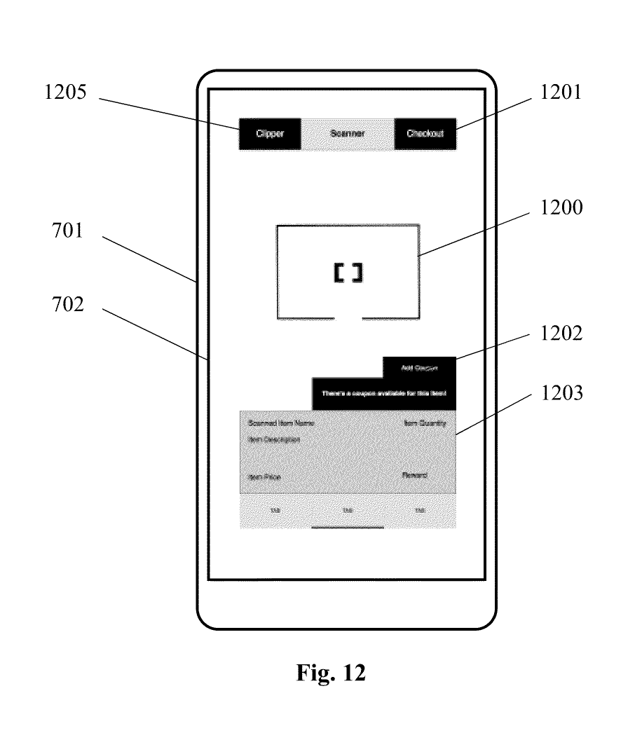

Referring now to FIG. 12 an exemplary coupon clipping screen of an alternate embodiment of the invention is depicted. It may be, from time to time, that a user desires to add coupon information such as coupon images or coupon bar codes copied from paper coupons and the like into the coupon list of the invention in order to present such coupons at checkout. In such situations, it may be advantageous that the invention comprise a coupon scanning function. The invention may thus comprise a coupon scanning and clipping function which may be initiated by navigating to a screen as depicted in FIG. 12. A coupon, which may comprise a coupon bar code, may be scanned using the optical scanning function of mobile electronic device 701, which may display an image of the scanned coupon image 1200 or coupon bar code on visual display 702. If the user desires to add the scanned coupon to a list of coupons in mobile electronic device 701 memory, button 1202 is selected. The invention may also present button 1205, which, when selected, may navigate to a screen that allows the user to crop the scanned coupon or coupon bar code image. Coupon information such as product identification, product price, available reward points, product quantity and coupon or product information may be displayed by the invention in window 1203. Coupon information may also be electronically downloaded into the mobile electronic device 701 and added to the coupon list by other means, such as, for example, downloaded through wireless communications systems including but not limited to RFID, cellular network, WiFi and other wireless communications systems. The user may proceed to checkout by selecting button 1201, which may present a sequential list of coupons or coupon bar codes for scanning by the legacy checkout system.

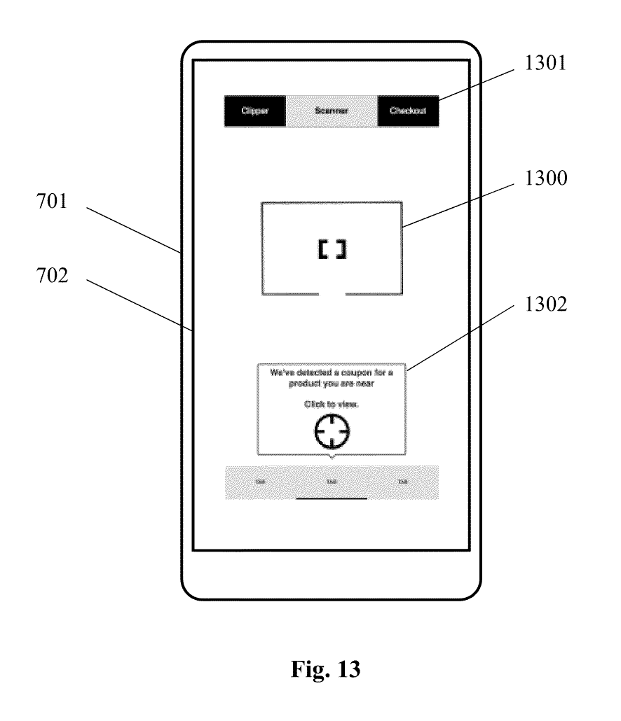

Referring now to FIG. 13 an exemplary coupon alert screen of an alternate embodiment of the invention is depicted. The invention may, after a product identifier is scanned by a user, search the World Wide Web, store database, or other database for available coupons for the product. If such coupon is identified, the invention may display the coupon, the product identifier, or other information in window 1300 and may provide screen area 1302 as an active link to more information about the coupon, whereupon the user may add the coupon to the coupon list in the mobile electronic device 701 memory. The user may proceed to checkout by selecting button 1301, which may present a sequential list of coupons for scanning by the legacy checkout system.

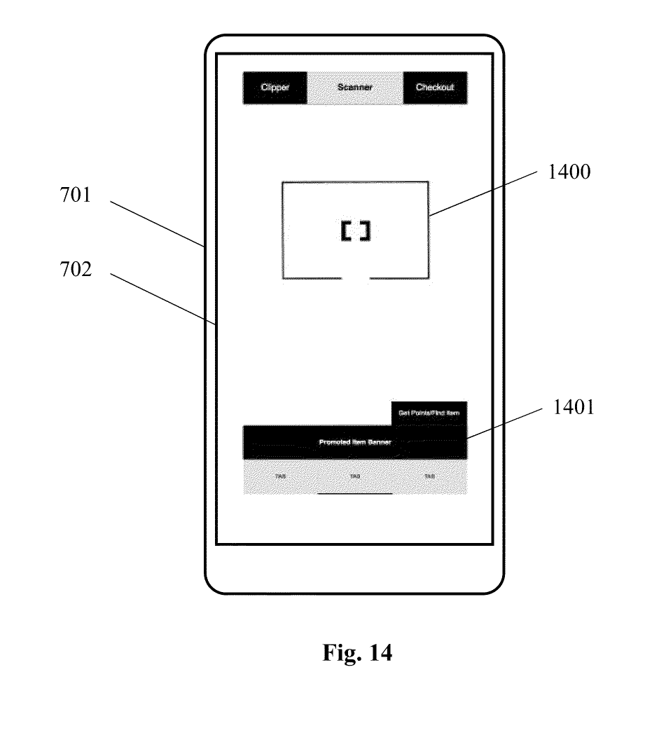

Referring now to FIG. 14, an exemplary product promotion screen of an alternate embodiment of the invention is depicted. The invention may comprise part of a system that allows product promotion by paid advertisers, or other product promotion. Thus, the invention may promote products based upon such paid advertisements, or the invention may utilize user shopping history data stored by the invention to select products for promotion, or both. A promoted product may be presented to the user on a screen such as the screen depicted in FIG. 14. Window 1400 may present promoted product information such as the name of the product, special offers regarding the product, time limitations of such offers, product pricing information, product description, product image and the like. Further product information may be provided in product banner 1401.

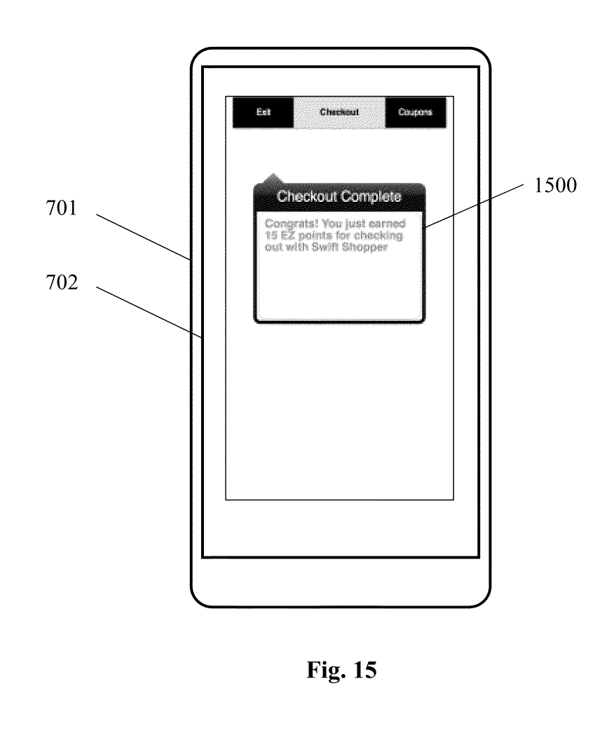

Referring now to FIG. 15, an exemplary reward congratulation screen of an alternate embodiment of the invention is depicted. Upon checkout or other event, the invention may display window 1500 which may present a congratulation message to the user and may also verify that certain reward points have been earned by the user's use of the invention to purchase products. The invention may also post a message to the user's social media, such as, for example, Facebook or Twitter, indicating that the user has had a pleasurable experience using the invention, or some other message indicating a positive experience with the invention.

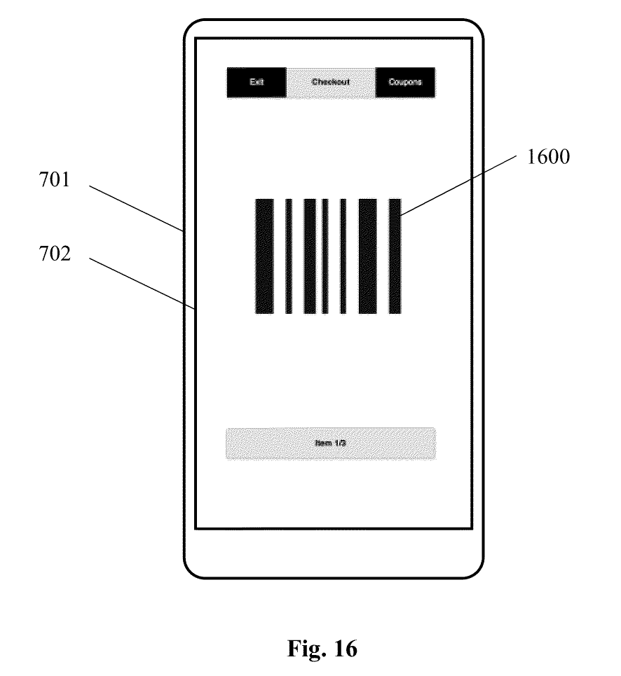

Referring now to FIG. 16, an exemplary screen shot of the visual display 702 of the mobile electronic device 701 is depicted in which the visual display 702 presents a product identifier 1600 for scanning by the legacy checkout system. The product identifier may be a bar code as shown in the example or may be any other identifier known in the art for identification of a product. In the preferred embodiment of the invention, each product that has been scanned by the user and is desired to be purchased is sequentially displayed on the mobile electronic device 701 visual display 702 for scanning by a legacy checkout system.

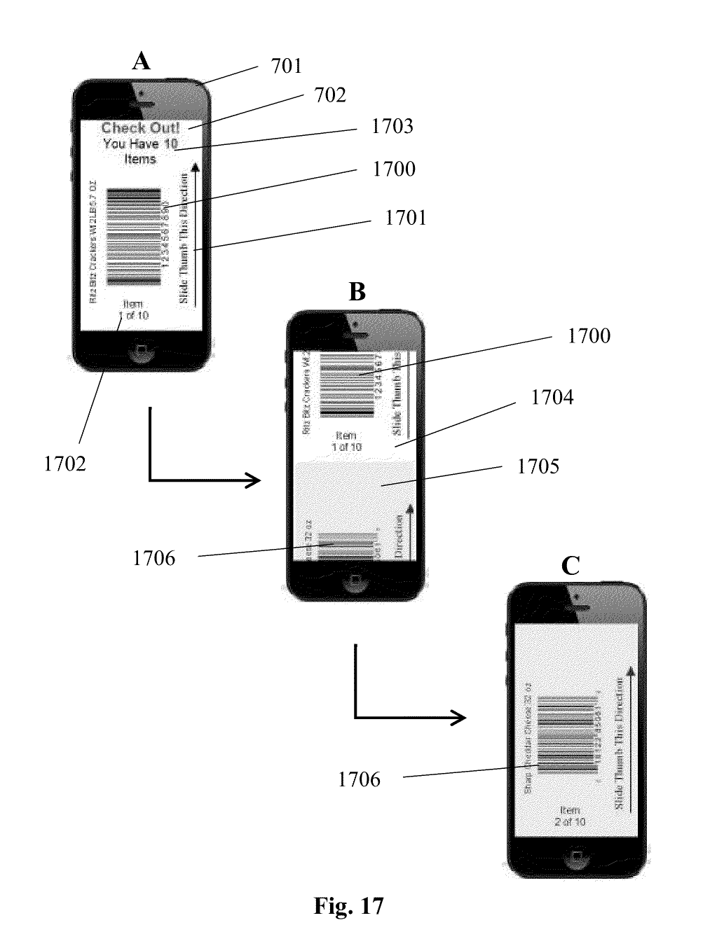

Referring now to FIG. 17, several exemplary steps of the checkout process in which a sequence of product identifiers are presented on the mobile electronic device 701 visual display 702 are depicted. This figure is intended to depict an exemplary method for sequential display of product identifiers to a legacy checkout scanning system in a preferred embodiment of the invention. In the example shown, the mobile electronic device 701 comprises a touch screen; however it is understood that this embodiment is exemplary and is not limiting. Thus any method and structure for inputting commands into a mobile electronic device 701 such as track balls, keyboard entry, voice command, and any other method for inputting commands known in the art is included within the scope of the invention. A first product to be purchased has a product identifier 1700 that is displayed on mobile electronic device visual display 702 in first step A. A swipe indicator 1701 may be displayed, which may indicate to a user that a thumb swipe in the direction of the indicator will cause the next product identifier to be displayed. The product's location in the sequence of products to be purchased may be indicated by nomenclature 1702, and the total number of products to be purchased, may be indicated by nomenclature 1703. After the first product identifier 1700 has been scanned by the legacy checkout system, the user may instruct the mobile electronic device 701 to display the second product identifier by, for the example shown, swiping a thumb in the direction indicated by swipe indicator 1701, which causes the second product identifier 1706 to begin to appear on mobile electronic device 701 visual display 702 as shown in step B. The visual backgrounds of sequential product identifiers may be comprised of alternating colors or shades in order to provide a visual delineator between product identifiers. In the example shown in FIG. 17, the first product identifier utilizes a white background 1704, and the second product identifier utilizes a light turquoise background 1705; however it is understood that any color or shade may be implemented and the selection of a particular color is not a limitation on the scope of the claims. In step C, it is depicted that the second product identifier is displayed upon mobile electronic device 701 visual display 702 and is ready for scanning by the legacy scanning checkout system. In this manner each of the product identifiers for products desired to be purchased scanned by the user may be sequentially displayed upon mobile electronic device 701 visual display 702 for scanning by the legacy scanning checkout system.

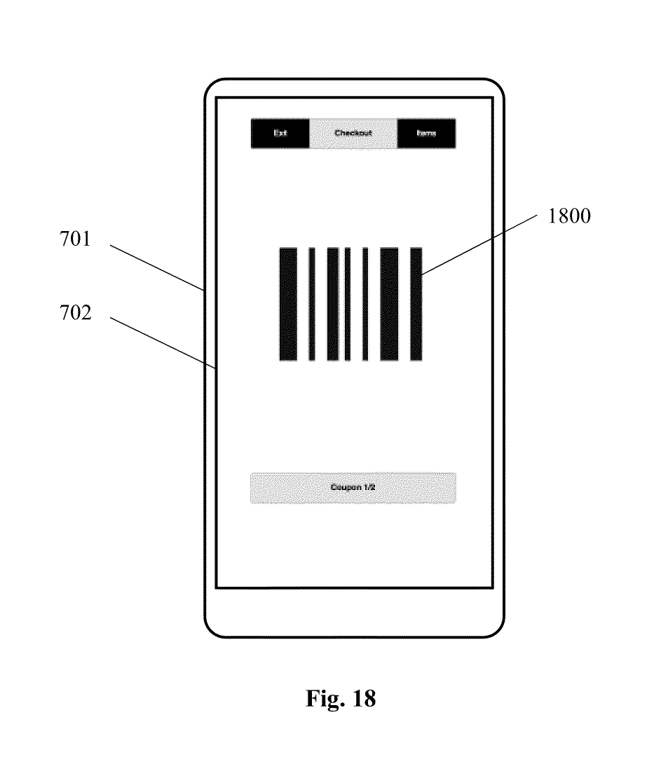

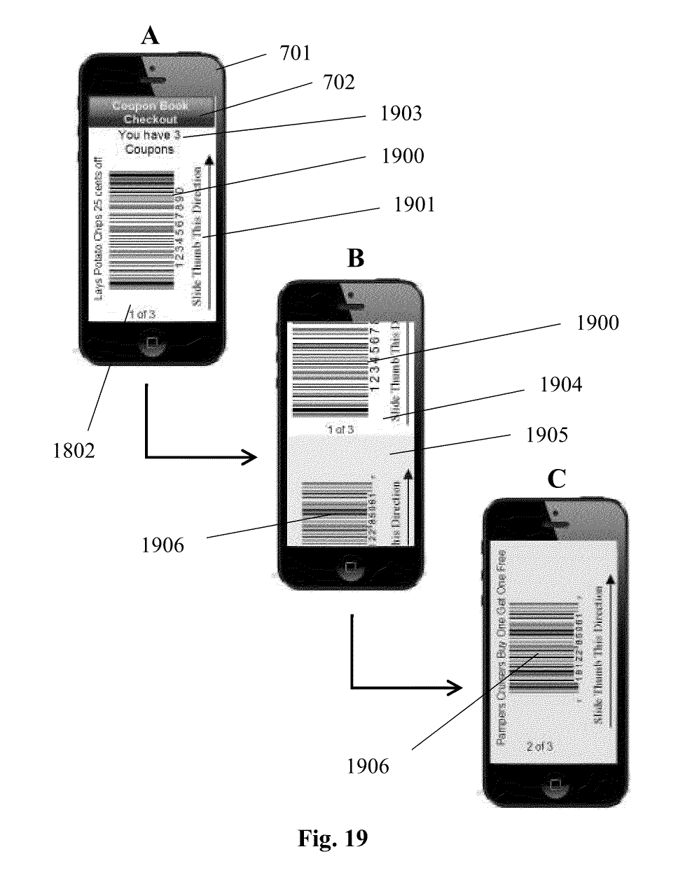

Referring now to FIG. 18, an exemplary screen shot of an alternate embodiment of the invention is depicted, which shows coupon bar code 1800 displayed on visual screen 702 of mobile electronic device 701. Coupon bar code 1800 may be one of a plurality of coupon bar codes that have been scanned and entered into the memory of mobile electronic device 701. Each bar code may be displayed in sequence on visual display 702 whereupon they may be scanned by the legacy checkout scanning system. By presentation of coupon bar codes in this or a similar manner, the user may take advantage of bar coded coupons that have been entered into the memory of mobile electronic device 701. One exemplary method for sequential display of coupon bar codes is further shown in FIG. 19 and described below.

Referring now to FIG. 19, several exemplary steps of the checkout process in which a sequence of coupon bar codes are presented on the mobile electronic device 701 visual display 702 are depicted. This figure is intended to depict an exemplary method for sequential display of coupon bar codes 1900 to a legacy checkout scanning system in a preferred embodiment of the invention. In the example shown, the mobile electronic device 701 comprises a touch screen; however it is understood that this embodiment is exemplary and is not limiting. Thus any method and structure for inputting commands into a mobile electronic device 701 such as track balls, keyboard entry, voice command, and any other method for inputting commands known in the art is included within the scope of the invention. A first coupon has a coupon bar code 1900 that is displayed on mobile electronic device 701 visual display 702 in first step A. A swipe indicator 1901 may be displayed, which may indicate to a user that a vertical thumb swipe will cause the next coupon bar code 1900 to be displayed. The coupon's location in the sequence of coupons to be presented may be indicated by nomenclature 1902, and the total number of coupons to be presented may be indicated by nomenclature 1903. After the first coupon bar code 1900 has been scanned by the legacy checkout system, the user may instruct the mobile electronic device 701 to display the second coupon bar code 1906 by, for the example shown, swiping a thumb in the direction indicated by swipe indicator 1901, which causes the second coupon bar code 1906 to begin to appear on mobile electronic device 701 visual display 702 as shown in step B. The visual backgrounds of sequential coupon bar codes 1900 may be comprised of alternating colors or shades in order to provide a visual delineator between coupon bar codes. In the example shown in FIG. 17, the first coupon bar code utilizes a white background 1904, and the second coupon bar code 1906 utilizes a light turquoise background 1905; however it is understood that any color or shade may be implemented and the selection of a particular color is not a limitation on the scope of the claims. In step C, it is depicted that the coupon bar code 1900 is displayed upon mobile electronic device 701 visual display 702 and is ready for scanning by the legacy scanning checkout system. In this manner each of the coupon bar codes 1900 for products desired to be purchased by the user, or any other coupon bar code 1900, may be sequentially displayed upon mobile electronic device 701 visual display 702 for scanning by the legacy scanning checkout system.

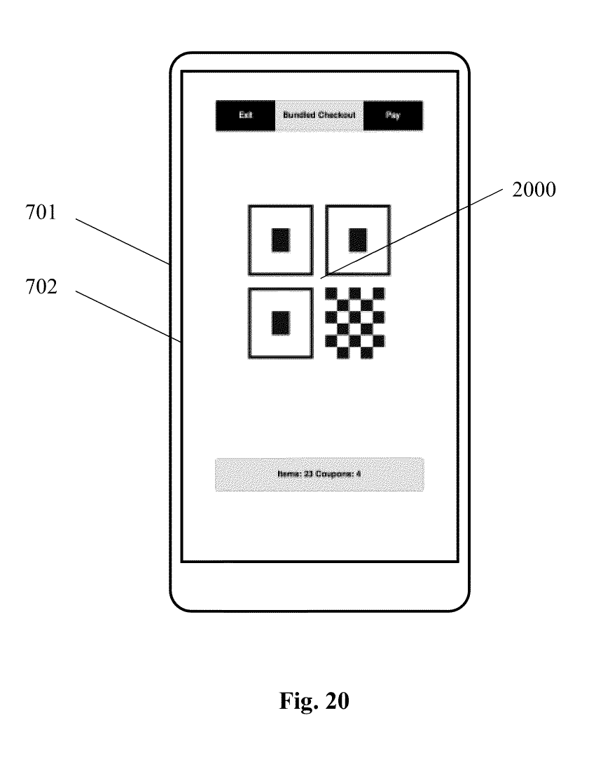

Referring now to FIG. 20, an exemplary screen shot of an alternate embodiment of the invention is depicted. In this alternate embodiment, a list of products to be purchased has been communicated to a remote server from a user's mobile electronic device 701. The remote server may then bundle certain bundled product purchase information such as product identification information, product pricing information, user identification information, payment information and other information and related this information to a graphic symbol which may be a QR code. The bundled product purchase information may represent one or a plurality of products to be purchased. The graphic symbol is then communicated from the remote server to the mobile electronic device 701 where it may be displayed as graphic symbol 2000. Graphic symbol 2000 may then be scanned by the legacy checkout scanning system, upon which the legacy checkout system may communicate with the remote server using the link information provided in the graphic symbol, whereupon the user's product purchase information may be downloaded to the legacy checkout system and the user may complete the purchase of products in the usual and known methods for making payment. Alternatively, the user's financial information may be included in the bundled product purchase information and the purchase may be completed automatically, or the user may authorize the debit of funds from her financial account, whereupon the funds may be debited from her account and the purchase completed.

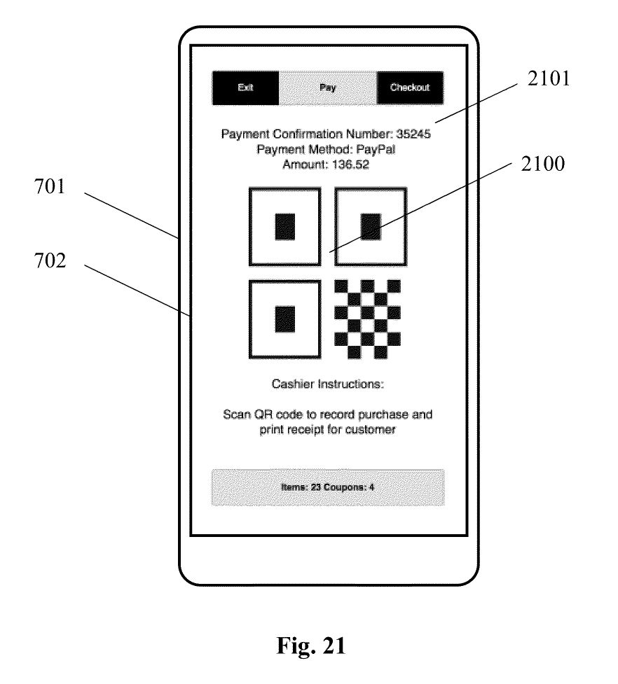

Referring now to FIG. 21, an exemplary screen shot of an alternate embodiment of the invention is depicted. In this alternate embodiment, graphic symbol 2100 containing a link to bundled product purchase information has been downloaded to the user's mobile electronic device 701 and displayed on visual display 702, in similar manner as described and shown in FIG. 20. Before or after the scanning of graphic symbol 2100 or before or after payment has been made the invention may display upon the user's mobile electronic device 701 a payment confirmation number 2101, and may also display the amount of the purchase and the method of payment, including the identity of the payment service or merchant service provider such as Visa, Mastercard, Paypal, Discover, American Express, or the like.

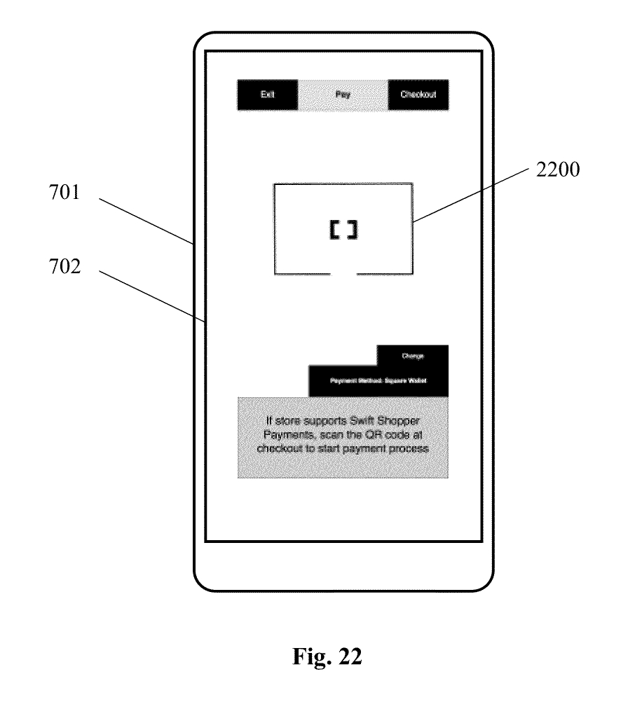

Referring now to FIG. 22, an exemplary screen shot of an alternate embodiment of the invention is depicted. In this alternate embodiment, a retail establishment may provide a QR or other graphic code or identifier that a user of the system may scan using the optical scanning feature of the mobile electronic device 701. Upon scanning the retail establishment QR or other graphic code, a replica of the QR, graphic code or other identifier of the retail establishment 2200 may be displayed upon the visual display 702 of mobile electronic device 701. In this manner the invention is able to ascertain the identity of the retail establishment, which information may be useful for many purposes such as provided user-targeted advertisements and messages, allowing the remote server to apply user-targeted discounts and other loyalty rewards, and the like.

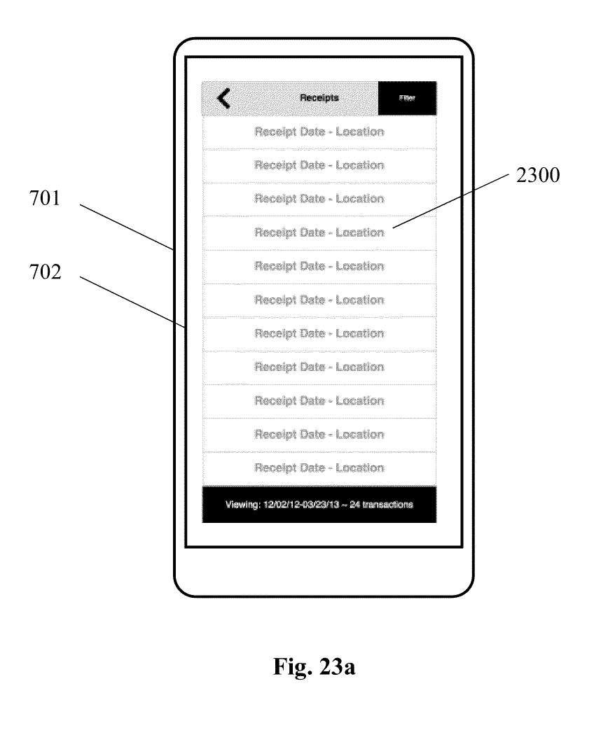

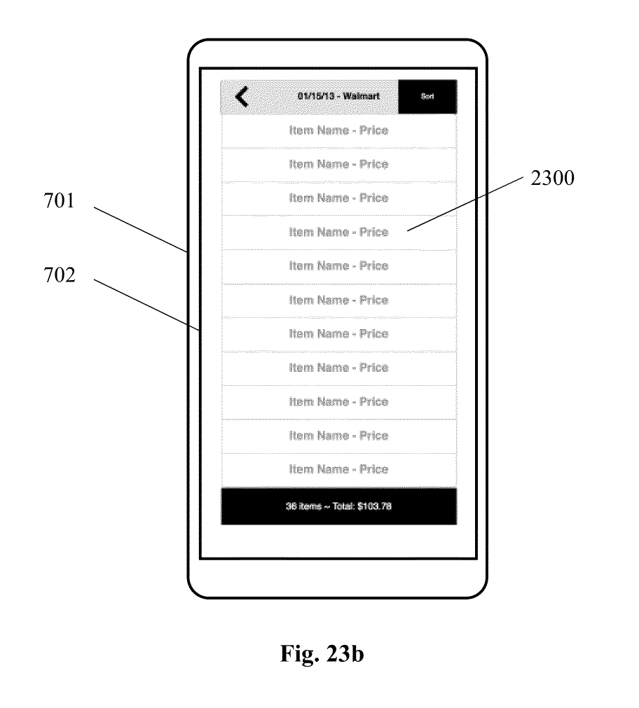

Referring now to FIGS. 23a and 23b, exemplary screen shots of an alternate embodiment of the invention is depicted. In this alternate embodiment the purchased products are listed for review by the user; this list by be sorted by price, identity of product or any other product information that has been stored in the memory of mobile electronic device 701.

In all of FIGS. 7-23b, mobile electronic device 701 having visual display 702 is depicted in exemplary fashion as a cellular telephone, such as a smart phone, but it is understood that this depiction is exemplary and that mobile electronic device 701 may be any mobile electronic device 701 known in the art.

In this disclosure the use of the terms shopping cart and shopping bag are exemplary and include any container which may be utilized by shopper to hold items which are desired to be purchased. Alternatively, there may be no container utilized as the shopper may simply carry the products which are desired to be purchased by hand or any other means. The matter and means of carrying items to be purchased is not to be considered a limitation of the invention.

In this disclosure the term “alphanumeric” means any combination of letters, number or graphic symbols. An alphanumeric identifier may consist of only letters, only numbers, only graphic symbols, or any combination thereof.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. An improved checkout system, comprising:
at least one mobile electronic device comprising a memory, a processor, an optical scanner, and a visual display, wherein said processor is in electrical communication with said memory and said visual display, and
wherein said mobile electronic device memory contains instructions to perform the steps of optically scanning a product identifier of at least one product to be purchased, storing said product identifier of said at least one product to be purchased, and displaying said product identifier of said at least one product to be purchased on said mobile electronic device visual display for presentation to a legacy scanning checkout system.

2. The improved checkout system of claim 1, wherein said product identifier is a bar code.

3. The improved checkout system of claim 1, wherein said mobile electronic device is further defined as being selected from the group consisting of a cellular telephone, an electronic tablet, and a personal digital assistant.

4. The improved checkout system of claim 2, wherein said mobile electronic device is further defined as being selected from the group consisting of a cellular telephone, a tablet, and a personal digital assistant.

5. The improved checkout system of claim 1, further comprising a legacy scanning checkout system, wherein said legacy scanning checkout system is adapted to optically scan said product identifier when said product identifier is displayed upon said mobile electronic device visual display.

6. The improved checkout system of claim 2, further comprising a legacy scanning checkout system, wherein said legacy scanning checkout system is adapted to optically scan said product identifier when said product identifier is displayed upon said mobile electronic device visual display.

7. The improved checkout system of claim 3, further comprising a legacy scanning checkout system, wherein said legacy scanning checkout system is adapted to optically scan said product identifier when said product identifier is displayed upon said mobile electronic device visual display.

8. The improved checkout system of claim 4, further comprising a legacy scanning checkout system, wherein said legacy scanning checkout system is adapted to optically scan said product identifier when said product identifier is displayed upon said mobile electronic device visual display.

9. The improved checkout system of claim 1, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

10. The improved checkout system of claim 2, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

11. The improved checkout system of claim 3, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

12. The improved checkout system of claim 4, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

13. The improved checkout system of claim 5, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

14. The improved checkout system of claim 6, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

15. The improved checkout system of claim 7, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

16. The improved checkout system of claim 8, wherein said mobile electronic device further comprises the capability to communicate with a remote server, and wherein said mobile electronic device further contains instructions to perform the steps of communicating with said remote server, transmitting said product identifier to said remote server, receiving a price for said product, and displaying said price on said mobile electronic device visual display.

17. An improved checkout system as in any one of claims 1-16, further comprising a remote server in wireless communication with said mobile electronic device;
wherein said remote server is adapted to receive a bundle comprising at least one product identifier from said mobile electronic device and to generate a graphic symbol containing product identification and pricing information that identifies a product and a price for each product identifier in said bundle,
and wherein said mobile electronic device is further adapted to perform the steps of creating said bundle of at least one product identifier, transmitting said bundle to said remote server, receiving said graphic symbol from said remote server, and displaying said graphic symbol on said mobile electronic device visual display.

18. An improved method for checkout, comprising;
Selecting at least one product for purchase, wherein said at least one product comprises a product identifier;
Optically scanning said at least one product identifier using a mobile electronic device;
Storing said at least one product identifier in a memory of said mobile electronic device;
Displaying said at least one product identifier on a visual display of said mobile electronic device;
Presenting said visual display of said mobile electronic device to a legacy scanning system; and
Scanning said visual display of said mobile electronic device using said legacy scanning checkout system while a product identifier is displayed upon said visual display of said mobile electronic device.

19. The improved method for checkout of claim 18, wherein said at least one product is further defined as a plurality of products each having a product identifier, and wherein said product identifiers of said plurality of products are sequentially displayed upon said visual display of said mobile electronic device when said visual display of said mobile electronic device is presented to said legacy scanning checkout system, and wherein said product of identifiers of said plurality of products are sequentially scanned by said legacy scanning checkout system.

20. The improved method for checkout of claim 18, wherein said product identifier is a bar code.

21. The improved method for checkout of claim 19, wherein said product identifier is a bar code

22. The improved method for checkout of claim 20, wherein said mobile electronic device is further defined as being selected from the group consisting of a cellular telephone, an electronic tablet, and a personal digital assistant.

23. The improved method for checkout of claim 21, wherein said mobile electronic device is further defined as being selected from the group consisting of a cellular telephone, a tablet, and a personal digital assistant.

24. The improved method for checkout of claim 18, further comprising the step of determining a total purchase price for said purchase.

25. The improved method for checkout of claim 19, further comprising the step of determining a total purchase price for said purchase.

26. The improved method for checkout of claim 20, further comprising the step of determining a total purchase price for said purchase.

27. The improved method for checkout of claim 21, further comprising the step of determining a total purchase price for said purchase.

28. The improved method for checkout of claim 22, further comprising the step of determining a total purchase price for said purchase.

29. The improved method for checkout of claim 23, further comprising the step of determining a total purchase price for said purchase.
